(19) United States
(12) Patent Application Publication
(10) Pub. No.: US 2025/0026559 A1
(43) Pub. Date: Jan. 23, 2025

(54) Party Activity Kit

(71) Applicants: Alicia Roberson, Killeen, TX (US); Darrell Roberson, Killeen, TX (US)

(72) Inventors: Alicia Roberson, Killeen, TX (US); Darrell Roberson, Killeen, TX (US)

(21) Appl. No.: 18/422,287

(22) Filed: Jan. 25, 2024

Related U.S. Application Data
(60) Provisional application No. 63/514,146, filed on Jul. 18, 2023.

(51) Int. Cl. B65D 85/36; A23G 3/28

(52) U.S. Cl. CPC B65D 85/36; A23G 3/28

(57) ABSTRACT

A party activity kit device is disclosed that is a unique kit which can be distributed at parties as a fun activity, as well as a dessert or take-home favor. The party activity kit device comprises a container component that is configured in a rectangular shape that is sized and shaped to hold at least two miniature cupcakes. The container component could be a white box with a clear top for viewing. The contents of the container component comprises at least two miniature cupcakes, miniature cakes, cookies, etc., or any other suitable small desserts. The miniature cupcakes would be available in different flavors and colors. Further, the container component comprises a plurality of decorating components, such as icing and/or sprinkles. The icing and/or sprinkles would be contained in self-locking plastic bags.

### CROSS-REFERENCE TO RELATED APPLICATION

The present application claims priority to, and the benefit of, U.S. Provisional Application No. 63/514,146, which was filed on Jul. 18, 2023, and is incorporated herein by reference in its entirety.

### FIELD OF THE INVENTION

The present invention relates generally to the field of party activity kit devices. More specifically, the present invention relates to a party kit that contains two colorful, bright, miniature cupcakes, icing, and sprinkles. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in party activity kit devices. Generally, party hosts are always looking for new activities to have at birthday parties, especially children's parties. Decorating cupcakes is a favorite activity for individuals of all ages. Not only is the experience of decorating enjoyable but the end product can be enjoyed as a dessert or a take-home favor.

Furthermore, users are always looking for birthday or other party activities that can be utilized with all age groups, without worrying about some partygoers being too young or too old to take part in the activity. Accordingly, it would be desirable to include such activities at the birthday party or other party, allowing all users to enjoy and take part in the birthday party.

Accordingly, there is a demand for an improved birthday party activity kit device that is suitable for users of all ages at a birthday or other party. More particularly, there is a demand for a birthday party activity kit device that not only provides a fun activity but provides an end product that can be enjoyed at the party or taken home.

Therefore, there exists a long-felt need in the art for a party activity kit device that provides users with a party kit that contains two colorful, bright, miniature cupcakes, icing, and sprinkles. There is also a long-felt need in the art for a party activity kit device that offers an exciting activity for kids to partake in at a birthday party. Further, there is a long-felt need in the art for a party activity kit device that entertains children, while allowing them to be creative and decorate their own cupcakes to eat or take home. Moreover, there is a long-felt need in the art for a device that affords a fun and independent activity that party hosts can pass out to guests. Further, there is a long-felt need in the art for a party activity kit device that can include miniature cakes or other desserts besides cupcakes in the kit. Finally, there is a long-felt need in the art for a party activity kit device that can be available in different flavors and colors.

The subject matter disclosed and claimed herein, in one embodiment thereof, comprises a party activity kit device. The device is a unique kit that can be distributed at parties as a fun activity, as well as a dessert or take-home favor. The party activity kit device comprises a container component that is configured in a rectangular shape that is sized and shaped to hold at least two miniature cupcakes. The container component could be a white box with a clear top for viewing. The contents of the container component comprises at least two miniature cupcakes, miniature cakes, cookies, etc., or any other suitable small desserts. The miniature cupcakes would be available in different flavors and colors. Further, the container component comprises a plurality of decorating components, such as icing and/or sprinkles, or any other suitable decorating components. The decorating components may also vary. The icing and/or sprinkles would be contained in self-locking plastic bags.

In this manner, the party activity kit device of the present invention accomplishes all of the foregoing objectives and provides users with a device that provides a fun and independent activity for party guests. The device is a kit that includes miniature cupcakes and decorating components. The device can be available in different flavors and colors.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a party activity kit device. The device is a unique kit that can be distributed at parties as a fun activity, as well as a dessert or take-home favor. The party activity kit device comprises a container component that is configured in a rectangular shape that is sized and shaped to hold at least two miniature cupcakes. Specifically, the contents of the container component comprise at least two miniature cupcakes, miniature cakes, cookies, etc., or any other suitable small desserts. Further, the container component comprises a plurality of decorating components, such as icing and/or sprinkles, or any other suitable decorating components. Party guests can then each receive a party activity kit device. Party guests can then open the kit device and utilize the enclosed decorating components to decorate and embellish their cupcakes. Afterward, party guests can either eat the decorated cupcakes at the party, as a dessert or bring them home after the party, as a take-home favor.

In one embodiment, the party activity kit device comprises a container component that is a rectangular receptacle for the desserts held within the receptacle. Generally, the container component comprises opposing right and left sides, opposing front and back sides, a top side, and a bottom side, which are configured to form an inner cavity. In one embodiment, the container component is a white box with a transparent top side for viewing, such that the desserts can be seen. A portion or all or substantially all of the top surface is preferably transparent so that a large amount of the desserts can be seen. The transparent area is preferably made of a food-safe, clear material such as polyethylene, polystyrene, ABS, PVC, etc., or any other suitable material as is known in the art. Further, the inner cavity retains the desserts within the container component and can be any suitable shape and size as is known in the art. The container component would be comprised of food-safe materials, such as cardboard, plastic, or other suitable materials as is known in the art.

In one embodiment, a lid component is utilized to cover the inner cavity and replaces the top side. The lid component could also have a transparent area for viewing, as disclosed above. The lid component could be hinged to the front or back side or could be separate from the container component and just positioned to rest on top of the container component to seal the cupcakes within, such as a shoebox lid.

In one embodiment, the container component is configured in a rectangular shape, but can also be configured in any other suitable shape as is known in the art, such as square, oval, circular, etc. The container component is typically rectangular in shape, however, the other shapes are also suitable as the container component is merely needed for retaining the cupcakes or other small desserts. Further, the size of the container component is a matter of choice and any suitable size and shape is contemplated as is known in the art, as long as the container component is sized and shaped to hold multiple small desserts, such as miniature cupcakes. Thus, it generally has dimensions of height and width to accommodate at least two miniature cupcakes, two miniature cakes, or other suitable small desserts, etc.

In one embodiment, the dessert included in the container component comprises miniature cupcakes, miniature cakes, cookies, cinnamon rolls, muffins, etc., or any other suitable dessert as is known in the art, depending on the needs and/or wants of a user. The cupcakes or other suitable desserts can be any suitable color, flavor, size, etc., as is known in the art. Further, the cupcakes or other desserts can be gluten-free, dairy-free, nut-free, etc., depending on the needs and/or wants of a user or other party guests.

In one embodiment, the party activity kit device comprises decorating components, wherein one of the decorating components is icing. Any suitable flavor or color of icing can be included with the device. In one embodiment, multiple flavors of icing can be included with the kit device. The icing is typically stored in a self-locking 4″×6″ plastic bag or other suitable receptacle.

In one embodiment, the party activity kit device comprises decorating components, wherein one of the decorating components is sprinkles. Any suitable flavor or color of sprinkles can be included with the device. In one embodiment, multiple flavors of sprinkles can be included with the kit device. The sprinkles are typically stored in a self-locking 2″×2″ plastic bag or other suitable receptacle.

In use, the party activity kit device is assembled by placing at least two miniature cupcakes or other suitable desserts into the container component, along with decorating components, such as icing and sprinkles, and then securing the lid component. Once assembled, the party activity kit devices can be utilized at a party and each passed out to a separate party guest. Specifically, users can open the kit device and remove and decorate the cupcakes, using the icing and sprinkles, as desired. Once decorated, the cupcakes are placed back into the container component, and the lid is replaced. Users can then enjoy the decorated cupcakes as a dessert at the party, or after the party, as a take-home favor.

In one embodiment, the party activity kit device can be used at any suitable party, such as a birthday party, a bridal shower, a baby shower, an anniversary party, etc., as is known in the art, even with birthday parties for pets, etc. (which would include pet-safe treats in the container component), depending on the needs and/or wants of a user.

In yet another embodiment, the party activity kit device comprises a plurality of indicia.

In yet another embodiment, a method of providing a party kit is disclosed. The method includes the steps of providing a party activity kit device comprising a container component comprising at least two miniature cupcakes and decorating components. The method also comprises removing the cupcakes and decorating components from the container component for use. Further, the method comprises using the decorating components to decorate the cupcakes, as desired. Finally, the method comprises eating the decorated cupcakes or packaging the cupcakes up to take home.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a top perspective view of one embodiment of the party activity kit device of the present invention showing the container component of the device in accordance with the disclosed architecture;

FIG. 2 illustrates a top perspective view of one embodiment of the party activity kit device of the present invention showing the two miniature cupcakes of the device in accordance with the disclosed architecture;

FIG. 3 illustrates a perspective view of one embodiment of the party activity kit device of the present invention showing the icing from the kit in accordance with the disclosed architecture;

FIG. 4 illustrates a perspective view of one embodiment of the party activity kit device of the present invention showing the sprinkles from the kit in accordance with the disclosed architecture;

FIG. 5 illustrates a perspective view of one embodiment of the party activity kit device of the present invention showing the kits assembled in accordance with the disclosed architecture; and

FIG. 6 illustrates a flowchart showing the method of providing a party kit in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a party activity kit device that provides users with a party kit that contains two colorful, bright, miniature cupcakes, icing, and sprinkles. There is also a long-felt need in the art for a party activity kit device that offers an exciting activity for kids to partake in at a birthday party. Further, there is a long-felt need in the art for a party activity kit device that entertains children, while allowing them to be creative and decorate their own cupcakes to eat or take home. Moreover, there is a long-felt need in the art for a device that affords a fun and independent activity that party hosts can pass out to guests. Further, there is a long-felt need in the art for a party activity kit device that can include miniature cakes or other desserts besides cupcakes in the kit. Finally, there is a long-felt need in the art for a party activity kit device that can be available in different flavors and colors.

The present invention, in one exemplary embodiment, is a novel party activity kit device. The device is a unique kit that can be distributed at parties as a fun activity, as well as a dessert or take-home favor. The party activity kit device comprises a container component that is configured in a rectangular shape that is sized and shaped to hold at least two miniature cupcakes. The container component could be a white box with a clear top for viewing. The contents of the container component comprises at least two miniature cupcakes, miniature cakes, cookies, etc., or any other suitable small desserts. Further, the container component comprises a plurality of decorating components, such as icing and/or sprinkles. The icing and/or sprinkles would be contained in self-locking plastic bags. The present invention also includes a novel method of providing a party kit. The method includes the steps of providing a party activity kit device comprising a container component comprising at least two miniature cupcakes and decorating components. The method also comprises removing the cupcakes and decorating components from the container component for use. Further, the method comprises using the decorating components to decorate the cupcakes, as desired. Finally, the method comprises eating the decorated cupcakes or packaging the cupcakes up to take home.

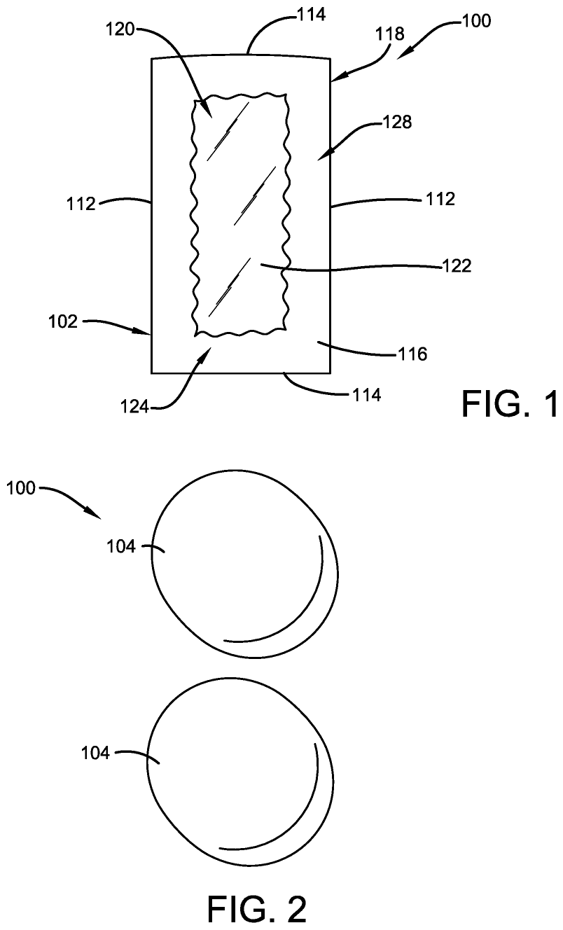

Referring initially to the drawings, FIG. 1 illustrates a perspective view of one embodiment of the party activity kit device 100 of the present invention. In the present embodiment, the party activity kit device 100 is an improved party activity kit device 100 that provides a user with a unique kit that can be distributed at parties as a fun activity, as well as a take-home favor. Specifically, the party activity kit device 100 comprises a container component 102 with at least two cupcakes 104 and decorating components 106. The decorating components 106 include icing 108 and/or sprinkles 110, or any other suitable decorating components 106. Party guests can then each receive a party activity kit device 100. Party guests can then open the kit device 100 and utilize the enclosed decorating components 106 to decorate and embellish their cupcakes 104. Afterward, party guests can either eat the decorated cupcakes 104 at the party, as a dessert or bring them home after the party, as a take-home favor.

Generally, the party activity kit device 100 comprises a container component 102 that is a rectangular receptacle for the desserts 104 held within the receptacle. Typically, the container component 102 comprises opposing right and left sides 112, opposing front and back sides 114, a top side 116, and a bottom side 118, which are configured to form an inner cavity 120. In one embodiment, the container component 102 is a white box with a transparent top side 122 for viewing, such that the desserts 104 can be seen. A portion or all or substantially all of the top surface 116 is preferably transparent 122 so that a large amount of the desserts 104 can be seen. The transparent area 122 is preferably made of a food-safe, clear material such as polyethylene, polystyrene, ABS, PVC, etc., or any other suitable material as is known in the art. Further, the inner cavity 120 retains the desserts 104 within the container component 102 and can be any suitable shape and size as is known in the art. The container component 102 would be comprised of food-safe materials, such as cardboard, plastic, or other suitable materials as is known in the art.

Furthermore, in one embodiment, a lid component 124 is utilized to cover the inner cavity 120 and replaces the top side 116. The lid component 124 could also have a transparent area 122 for viewing, as disclosed above. The lid component 124 could be hinged to the front or back side 114 or could be separate from the container component 102 and just positioned to rest on top of the container component 102 to seal the cupcakes 104 within, such as a shoebox lid.

Additionally, the container component 102 is configured in a rectangular shape, but can also be configured in any other suitable shape as is known in the art, such as square, oval, circular, etc. The container component 102 is typically rectangular in shape, however, the other shapes are also suitable as the container component 102 is merely needed for retaining the cupcakes 104 or other small desserts. Further, the size of the container component 102 is a matter of choice and any suitable size and shape is contemplated as is known in the art, as long as the container component 102 is sized and shaped to hold multiple small desserts, such as miniature cupcakes 104. Thus, it generally has dimensions of height and width to accommodate at least two miniature cupcakes 104, two miniature cakes, or other suitable small desserts, etc., as is known in the art, depending on the needs and/or wants of a user.

Furthermore, the container component 102 can also comprise ornamentation 126, designs, or ornamental elements on the outside surface 128 to match the aesthetic of the party, etc. Further, references to ornamentation 126, designs, or ornamental elements refer to any and all visible characteristics of the outer surface 128 of the container component 102. Accordingly, these terms may refer to the color, texture, pattern, decoration, or design of the outside surface 128. Also included are physically separate elements, such as beads, stones, buttons, feathers, fur, etc., which may be attached to the outside surface 128. Thus, ornamentation includes any combination of such characteristics or elements.

As shown in FIG. 2, the dessert 104 included in the container component 102 comprises miniature cupcakes, miniature cakes, cookies, cinnamon rolls, muffins, scones, doughnuts, etc., or any other suitable dessert as is known in the art, depending on the needs and/or wants of a user. The cupcakes 104 or other suitable desserts can be any suitable color, flavor, size, etc., as is known in the art. Further, the cupcakes 104 or other desserts can be gluten-free, dairy-free, nut-free, etc., depending on the needs and/or wants of a user or other party guests.

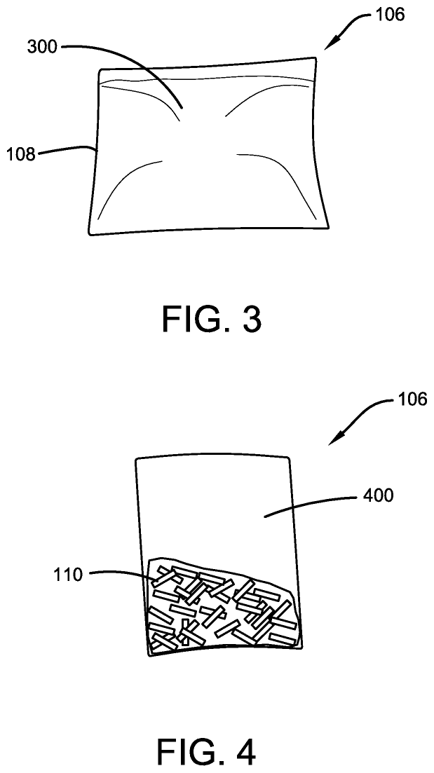

As shown in FIG. 3, the party activity kit device 100 comprises decorating components 106, wherein one of the decorating components 106 is icing 108. Any suitable flavor or color of icing 108 can be included with the device 100. In one embodiment, multiple flavors of icing 108 can be included with the kit device 100. The icing 108 is typically stored in a self-locking 4″×6″ plastic bag 300 or other suitable receptacle. The icing 108 can be stored in any suitable receptacle as is known in the art, as long as the icing 108 can be easily stored and utilized as needed within such receptacle.

As shown in FIG. 4, the party activity kit device 100 comprises decorating components 106, wherein one of the decorating components 106 is sprinkles 110. Any suitable flavor or color of sprinkles 110 can be included with the device 100. In one embodiment, multiple flavors of sprinkles 110 can be included with the kit device 100. The sprinkles 110 are typically stored in a self-locking 2″×2″ plastic bag 400 or other suitable receptacle. The sprinkles 110 can be stored in any suitable receptacle as is known in the art, as long as the sprinkles 110 can be easily stored and utilized as needed within such receptacle.

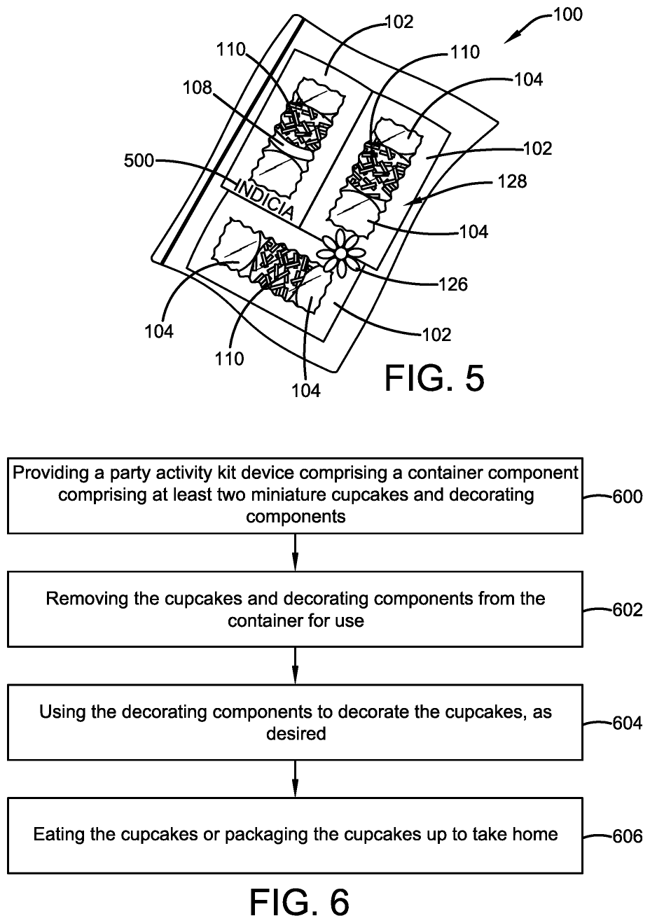

As shown in FIG. 5, in use, the party activity kit device 100 is assembled by placing at least two miniature cupcakes 104 or other suitable desserts into the container component 102, along with decorating components 106, such as icing 108 and sprinkles 110, then securing the lid component 124. Once assembled, the party activity kit devices 100 can be utilized at a party and each passed out to a separate party guest. Specifically, users can open the kit device 100 and remove and decorate the cupcakes 104, using the icing 108 and sprinkles 110, as desired. Once decorated, the cupcakes 104 are placed back into the container component 102 and the lid 124 is replaced. Users can then enjoy the decorated cupcakes 104 as a dessert at the party, or after the party, as a take-home favor.

Generally, the party activity kit device 100 can be used at any suitable party, such as a birthday party, a bridal shower, a baby shower, an anniversary party, etc., as is known in the art, even with birthday parties for pets, etc. (which would include pet-safe treats in the container component 102), depending on the needs and/or wants of a user.

In yet another embodiment, the party activity kit device 100 comprises a plurality of indicia 500. The container component 102 of the device 100 may include advertising, a trademark, or other letters, designs, or characters, printed, painted, stamped, or integrated into the container component 102, or any other indicia 500 as is known in the art. Specifically, any suitable indicia 500 as is known in the art can be included, such as, but not limited to, patterns, logos, emblems, images, symbols, designs, letters, words, characters, animals, advertisements, brands, etc., that may or may not be cupcake, party, or brand related.

FIG. 6 illustrates a flowchart of the method of providing a party kit. The method includes the steps of at 600, providing a party activity kit device comprising a container component comprising at least two miniature cupcakes and decorating components. The method also comprises at 602, removing the cupcakes and decorating components from the container component for use. Further, the method comprises at 604, using the decorating components to decorate the cupcakes, as desired. Finally, the method comprises at 606, eating the decorated cupcakes or packaging the cupcakes up to take home.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “party activity kit device”, “kit device”, “party device”, and “device” are interchangeable and refer to the party activity kit device 100 of the present invention.

Notwithstanding the foregoing, the party activity kit device 100 of the present invention can be of any suitable size and configuration as is known in the art without affecting the overall concept of the invention, provided that it accomplishes the above-stated objectives. One of ordinary skill in the art will appreciate that the party activity kit device 100 as shown in FIGS. 1-6 is for illustrative purposes only, and that many other sizes and shapes of the party activity kit device 100 are well within the scope of the present disclosure. Although the dimensions of the party activity kit device 100 are important design parameters for user convenience, the party activity kit device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A party activity kit device that provides a user with a unique kit that can be distributed at parties, the party activity kit device comprising:
a container component;
a dessert; and
a decorating component;
wherein the dessert is housed within the container component for storage;
wherein a user uses the decorating component to decorate the dessert at a party; and
further wherein the user after decorating the dessert can either eat the dessert at the party or bring the dessert home after the party, as a take-home favor.

2. The party activity kit device of claim 1, wherein the container component is a rectangular receptacle for the dessert.

3. The party activity kit device of claim 2, wherein the container component comprises opposing right and left sides, opposing front and back sides, a top side and a bottom side.

4. The party activity kit device of claim 3, wherein the opposing right and left sides, opposing front and back sides, the top side and the bottom side are configured to form an inner cavity.

5. The party activity kit device of claim 4, wherein the container component is a white box with a transparent area for viewing, such that the dessert can be seen.

6. The party activity kit device of claim 5, wherein the top side includes a transparent area.

7. The party activity kit device of claim 6, wherein the transparent area is preferably made of a food-safe, clear material such as polyethylene, polystyrene, ABS, or PVC.

8. The party activity kit device of claim 7, wherein the container component is comprised of food-safe materials, such as cardboard or plastic.

9. The party activity kit device of claim 8, wherein the top side is replaced with a lid component that is utilized to cover the inner cavity.

10. The party activity kit device of claim 9, wherein the lid component is hinged to the front or back side.

11. The party activity kit device of claim 10, wherein the container component comprises ornamentation, designs, or ornamental elements on an outside surface to match aesthetic of the party.

12. The party activity kit device of claim 11, wherein the dessert comprises at least two miniature cupcakes, miniature cakes, cookies, cinnamon rolls, muffins, scones, or doughnuts.

13. The party activity kit device of claim 12, wherein the decorating component is icing.

14. The party activity kit device of claim 13, wherein the decorating component is sprinkles.

15. A party activity kit device that provides a user with a unique kit that can be distributed at parties, the party activity kit device comprising:
a container component that is a rectangular receptacle with an inner cavity;
at least two miniature cupcakes; and
a decorating component that comprises icing and sprinkles;
wherein the at least two miniature cupcakes are housed within the inner cavity of the container component for storage;
wherein the container component is a white box with a transparent area for viewing, such that the at least two miniature cupcakes can be seen;
wherein the container component comprises a hinged lid component that is utilized to cover the inner cavity;
wherein a user uses the icing and sprinkles to decorate the at least two miniature cupcakes at a party; and
further wherein the user after decorating the at least two miniature cupcakes can either eat the at least two miniature cupcakes at the party or bring the at least two miniature cupcakes home after the party, as a take-home favor.

16. The party activity kit device of claim 15, wherein multiple flavors of icing can be included with the party activity kit device.

17. The party activity kit device of claim 16, wherein the icing is stored in a self-locking 4″×6″ plastic bag.

18. The party activity kit device of claim 15, wherein the sprinkles are stored in a self-locking 2″×2″ plastic bag.

19. The party activity kit device of claim 18 further comprising a plurality of indicia.

20. A method of providing a party kit, the method comprising the following steps:
providing a party activity kit device comprising a container component comprising at least two miniature cupcakes and decorating components;
removing the cupcakes and decorating components from the container component for use; using the decorating components to decorate the cupcakes, as desired; and
eating the decorated cupcakes or packaging the cupcakes up to take home.
